(19) United States
(12) Patent Application Publication
(10) Pub. No.: US 2016/0130123 A1
(43) Pub. Date: May 12, 2016

(54) BATTERY POWERED JACK APPARATUS

(71) Applicant: John D. Young, Mobile, AL (US)

(72) Inventor: John D. Young, Mobile, AL (US)

(21) Appl. No.: 14/536,406

(22) Filed: Nov. 7, 2014

(51) Int. Cl. B66F 3/44

(52) U.S. Cl. CPC B66F 3/44

(57) ABSTRACT

A preferred embodiment of the invention is directed to a jack apparatus that is electrically operated with a rechargeable battery. The jack apparatus has a base section and a telescopic jack and wrench. The wrench is most preferably a power lug wrench for removing the lug nuts from an automobile, but any socket, bit, or connection available for power drills is compatible. One embodiment comprises the apparatus having a 12 v outlet cord in addition to the battery. A preferred embodiment comprises the jack apparatus having a power inverter housed therein.

### FIELD OF THE INVENTION

A preferred embodiment of the invention refers to an apparatus and method for a powered jack relating to auto jacks and more specifically to a battery powered jack apparatus with a wrench, which may be employed in elevating a portion of an automobile and for any other use that selectively extends the attachable jack. A preferred embodiment of the invention refers, more specifically, to a portable jack with a rechargeable battery connected to a base, with a wrench further attached to the base.

### BACKGROUND

A jack is a mechanical device used as a lifting device to lift heavy loads or apply great forces. A mechanical jack employs a screw thread for lifting heavy equipment. The most common form is a car jack, floor jack, or garage jack that lifts vehicles so that maintenance can be performed. More powerful jacks use hydraulic power to provide more lift over greater distances and can be rated for many tons of load.

There are many different types of jacks. For example, scissor car jacks usually use mechanical advantage to allow a human to lift a vehicle by manual force alone. Another example is a house jack, also called a screw jack. A screw jack is a mechanical device primarily used to lift buildings from their foundations for repairs or relocation.

For many people, especially the elderly and those with disabilities, manually lifting a car or other heavy object with a manual jack is not possible, or is very difficult. In addition to those not capable of manually operating a manual jack, there are safety concerns associated with being near the jack while operating it, such as the object slipping from the jack. Therefore, there is a need in the art for a jack that is electrically operated with a rechargeable battery. Additionally, there is a need in the art for a battery powered jack that also has a powered wrench attached thereto.

### SUMMARY

A preferred embodiment of the invention is directed to a jack that is electrically operated with a rechargeable battery. Additionally an embodiment provides for a battery powered jack that also has a powered wrench attached thereto.

Preferably the jack apparatus has a base section and a telescopic jack. The telescopic jack has two or more pieces for lifting an object. While the telescoping jack configuration is most ideal, other embodiments of the invention may also comprise other types of jacks.

The invention comprises various battery configurations. One implementation comprises the battery being attached directly to the base. Other embodiments comprise the battery connecting to the base via an aperture on the base, clamps, wires, or quick release snaps.

A further implementation of the battery powered jack comprises a 12 v outlet cord for a secondary power source for the jack. This 12 v outlet cord is capable of being inserted into an automobile's cigarette/cigar lighter outlet.

One object of the current invention is to provide a jack for lifting an automobile. In such embodiments, it may be necessary to have a jack with 110V-120V power. Therefore, a preferred implementation of the current invention comprises the jack having a power inverter housed therein. In one embodiment the base section or battery connection base section may house an inverter for converting 12V to 110V-120V power.

The wrench of the present invention is most preferably a lug wrench for removing the lug nuts from an automobile. However, other implementations of the invention comprise the wrench having any socket, bit, or connection available for power drills.

### DESCRIPTION OF THE DRAWINGS

These and other features, aspects, and advantages of the present invention will become better understood with regard to the following description, appended claims, and accompanying drawings where:

FIG. 1 depicts a front perspective view of an apparatus embodying features of the present invention for a battery powered jack apparatus.

FIG. 2 shows a front perspective view of an apparatus embodying features of the present invention for a battery powered jack apparatus.

FIG. 3 shows a front view of an apparatus embodying features of the present invention for a battery powered jack apparatus.

FIG. 4 shows a front view of an apparatus embodying features of the present invention for a battery powered jack apparatus being used for changing the tire of an automobile.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

A “rechargeable battery” and grammatical equivalents used herein means a storage battery, secondary battery, or accumulator electrical battery. A rechargeable battery comprises one or more electrochemical cells, and is a type of energy accumulator used for electrochemical energy storage. It is technically known as a secondary cell because its electrochemical reactions are electrically reversible. It is understood that several different combinations of chemicals may be used for the rechargeable batteries used for the invention, including: lead-acid, nickel cadmium (NiCd), nickel metal hydride (NiMH), lithium ion (Li-ion), and lithium ion polymer (Li-ion polymer).

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

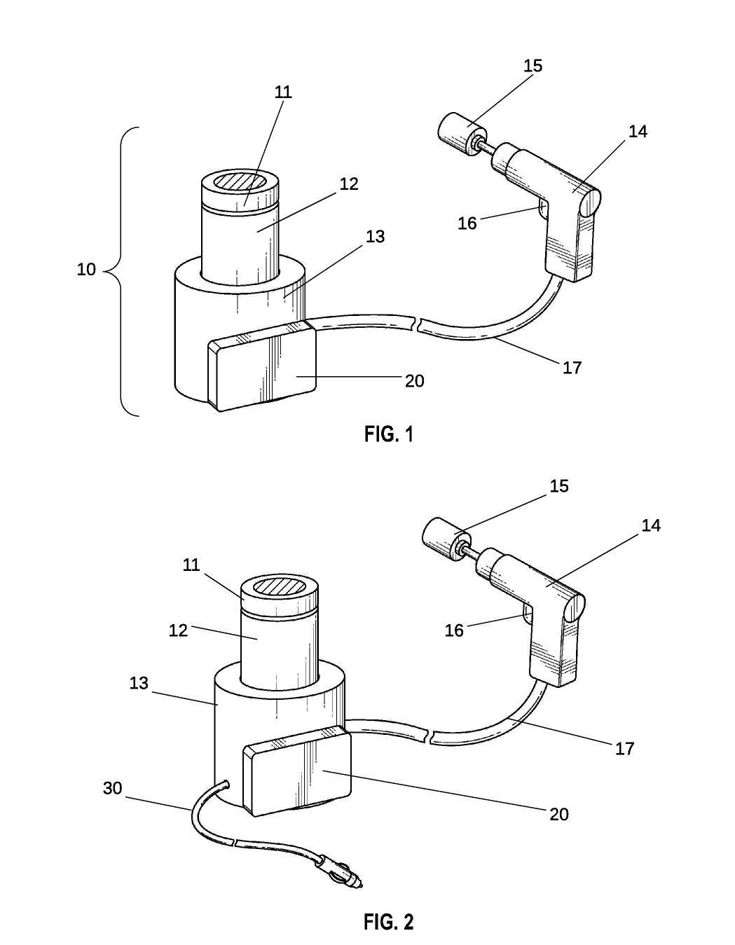

As set forth herein, a preferred embodiment of the invention comprises a battery operated jack. A preferred embodiment is illustrated in FIG. 1. The FIG. 1 embodiment shows the jack apparatus 10 having a base section 13. As shown in the picture, it is preferred that the base section 13 be wider than the telescopic jack 12 attached to the base section. As further illustrated in FIG. 1, the telescopic jack 12 may have more than one piece for lifting an object. The jack apparatus 10 may comprise a plurality of telescoping jack pieces. The FIG. 1 embodiment comprises the outer jack piece 12, a second jack piece (not pictured), and a third jack piece 11.

While the telescoping jack configuration is most ideal, other embodiments of the invention may also comprise other types of jacks. Alternative embodiments of the current invention may comprise any jack, or mechanical device used as a lifting device to lift heavy loads or apply great forces. The jack may employ a screw thread for lifting heavy equipment. This may comprise a car jack, floor jack, or garage jack which lifts vehicles so that maintenance can be performed. Other embodiments comprise more powerful jacks using hydraulic power to provide more lift over greater distances and can be rated for many tons of load.

The invention further comprises various battery configurations. As illustrated in FIG. 1 and FIG. 2, one implementation comprises the battery 20 being attached directly to the base 13. It is to be understood that the battery 20 shown in the figures is for illustration only, and that other sizes of batteries may be incorporated into the system and still fall within the claims and disclosure of this invention. In one embodiment the battery 20 connects to the base 13 via an aperture on the base. In that embodiment, the base 13 has an aperture for accepting a corresponding element of the battery 20 for being secured into the aperture. In another embodiment, the battery 20 is connected to the base 13 with clamps. In yet another embodiment, the battery 20 connects to the base 13 via quick release snaps.

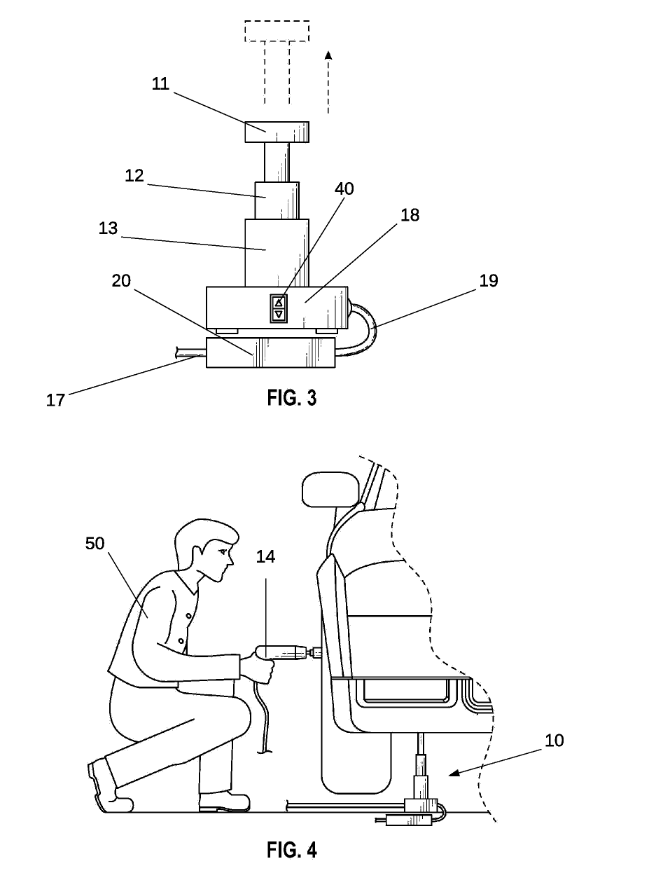

As illustrated in FIG. 3, the rechargeable battery 20 may stand-alone and not be connected directly to the base 13. In another embodiment, as shown in FIG. 3, the jack 10 may comprise a rechargeable battery 20 being attached to a battery connection base 18. In this embodiment the rechargeable battery 20 may be connected to the battery connection base 18 via a wired connection 19. It is understood that other connections as set forth herein, and commonly known in the art, may be suitable for this connection, and also fall within the scope of the invention. As illustrated in FIG. 3, the rechargeable battery 20 may also have a wired connection 17 for connection to a wrench 14.

As shown in FIG. 3, a preferred embodiment of the invention comprises a switch 40 for alternating the direction of the jack in an upward or downward direction. The switch 40 may be on the base section 13, or as in FIG. 3, on the battery connection base section 18. In one embodiment the switch 40 has a top, middle, and bottom setting. The top setting raises the jack. The middle setting turns the jack off. The bottom setting lowers the jack.

Shown in FIG. 2, one implementation of the battery powered jack further comprises a 12 v outlet cord 30 for a secondary power source for the jack. This 12 v outlet cord 30 is capable of being inserted into an automobile's cigarette/cigar lighter outlet.

One object of the current invention is to provide a jack for lifting an automobile. In such embodiments, it may be necessary to have a jack with 110V-120V power. Therefore, a preferred implementation of the current invention comprises the jack 10 having a power inverter housed therein. In a preferred embodiment, the base section 13 or battery connection base section 18 comprises an inverter for converting 12V to 110V-120V power.

As shown in FIG. 1 and FIG. 2, the wrench of the present invention is most preferably a power lug wrench 14 for removing the lug nuts from an automobile. As illustrated, the power lug wrench 14 comprises a lug socket 15 attached to the end of the lug wrench 14. The lug socket 15 is capable of attaching to lugs of automobiles for removing said lugs. The lug wrench 14 may also comprise a trigger 16 for activating the lug wrench. In a preferred embodiment the lug wrench 14 has a switch (not pictured) for alternating the direction in which the lug socket 15 rotates. In this preferred embodiment a user may alternate between the lug socket rotating clockwise or counterclockwise, depending on the orientation of the switch.

As shown in FIG. 3 and FIG. 4, one embodiment of the jack 10 comprises a jack element comprising a base 13 and a telescopic jack 12, 11 attached thereon. The battery 20 is connected to a battery connection base 18 by a removable element 19 for providing power to the jack. A wrench 14 is connected to the battery 20 by a removable element 17 for providing power to the wrench. As shown in FIG. 3, a switch 40 for controlling the direction of the telescopic jack is also provided.

Illustrated in FIG. 3, the telescoping jack may comprise at least a first 11 and second piece 12. The first piece 11 is housed inside the second piece 12. The first piece 11 rises above the second piece 12 to raise an object once the second piece reaches its maximum height.

In yet another embodiment, the battery operated jack of further comprising the telescopic jack having three pieces. For illustration, the telescopic piece may comprise a first piece 11 being house inside a second piece 12. In this implementation the second piece 12 may be housed inside the third piece 13. The first piece 11 rises above the second piece 12 to raise an object once the second piece 12 reaches its maximum height. The second piece 12 rises above the third piece 13 to raise an object once the third piece reaches its maximum height. The switch 40 controls the raising of each piece.

As illustrated in FIG. 3, the battery operated jack apparatus may comprise removable elements for providing power from the rechargeable battery to the jack and wrench. In one embodiment these removable elements are wires. In yet another embodiment the removable elements are sockets. In yet another embodiment, the removable element is an aperture and corresponding piece fore being secured inside the aperture.

It is understood that versions of the invention may come in different forms and embodiments. Additionally, it is understood that one of skill in the art would appreciate these various forms and embodiments as falling within the scope of the invention as disclosed herein.

1. A battery operated jack apparatus comprising:
a. A base section,
b. A telescopic jack connected to the base section, the telescopic jack being attached to the top of the base section, the base section configured to stabilize the jack upon a given surface,
c. A battery connected to the base section,
d. An electric wrench attached to the base, said electric wrench receiving power from the battery,
e. Said telescopic jack receiving power from the battery.

2. The jack apparatus of claim 1, further comprising:
a. The base section comprises a switch for alternating the direction of the telescopic jack in an upward or downward direction.

3. The jack apparatus of claim 1, further comprising:
a. The base section comprises a switch having a top, middle, and bottom setting,
b. The top setting raising the jack,
c. The middle section turning the jack off,
d. The bottom section lowering the jack.

4. The jack apparatus of claim 1, further comprising:
a. The base section further comprises a 12 v outlet cord for a secondary power source for the jack.

5. The jack apparatus of claim 1, further comprising:
a. The base section further comprising an inverter for converting 12 v power to 120 v power.

6. The jack apparatus of claim 5, the wrench comprising a power lug wrench for removing the leg nuts from an automobile.

7. A battery operated jack apparatus comprising:
a. A base section configured to accept a rechargeable battery therein,
b. A rechargeable battery for plugging into the base section and powering the apparatus,
c. A jack connected to the base section, the jack being attached to the top of the base section, the base section configured to stabilize the jack upon a given surface, the jack being telescopic such that it moves upwardly and downwardly,
d. A switch attached to the base section, said switch controlling the direction of the telescoping jack in an upward and downward direction,
e. An electric wrench attached to the base, said electric wrench receiving power from the battery.

8. The apparatus of claim 7, further comprising the base section further comprising an inverter for converting 12 v power to 120 v power.

9. The jack of claim 7, further comprising:
a. The base section comprises a switch having a top, middle, and bottom setting,
b. The top setting raising the jack,
c. The middle section turning the jack off,
d. The bottom section lowering the jack.

10. The jack apparatus of claim 8, the wrench comprising a power lug wrench for removing the lug nuts from an automobile.

11. A battery operated jack apparatus, comprising:
a. A jack element comprising a base and a telescopic jack attached thereon,
b. A battery connected to the base by a removable element for providing power to the telescopic jack,
c. A wrench connected to the battery by a removable element for providing power to the wrench, and
d. A switch for controlling the direction of the telescopic jack.

12. The battery operated jack of claim 11, further comprising:
a. Said telescoping jack comprising at least a first and second piece,
b. The first piece being housed inside the second piece,
c. The first piece rising above the second piece to raise an object once the second piece reaches its maximum height.

13. The battery operated jack of claim 11, further comprising:
a. Said telescopic jack comprising three pieces,
b. The first piece being house inside the second piece,
c. The second piece being housed inside the third piece,
d. The first piece rising above the second piece to raise an object once the second piece reaches its maximum height,
e. The second piece rising above the third piece to raise an object once the third piece reaches its maximum height,
f. The raising of each piece being controlled by the switch.

14. The battery operated jack of claim 11, further comprising said removable elements for providing power from the battery to the jack and the wrench are wires.

15. The battery operated jack of claim 11, further comprising said removable element for providing power to said wrench is a wire, and said removable element for providing power to said telescopic jack is a socket.
